(19) United States
(12) Patent Application Publication
(10) Pub. No.: US 2024/0046255 A1
(43) Pub. Date: Feb. 8, 2024

(54) COMPUTERIZED DISTRIBUTED LEDGER SYSTEM SUPPORTING FIXED-VALUE RESOURCE UNITS

(71) Applicant: CONCEPT HEDGING LLC, Ojai, CA (US)

(72) Inventor: Wayne PERG, Ojai, CA (US)

(21) Appl. No.: 17/753,478

(22) PCT Filed: Sep. 3, 2020
(86) PCT No.: PCT/US2020/049278

§ 371 Date: Mar. 3, 2022

Related U.S. Application Data
(60) Provisional application No. 62/895,612, filed on Sep. 4, 2019.

(51) Int. Cl. G06Q 20/38; G06Q 20/10

(52) U.S. Cl. CPC G06Q 20/381; G06Q 20/10

(57) ABSTRACT

Methods and systems of maintaining a digital ledger are provided in which a first resource, such as a cryptocurrency or other value-bearing resource, is backed by a second resource, such as a fiat currency or other government-issued resource, and exchangeable for the second resource at a set per-unit value. After setting a per-unit value of the first resource, interface nodes are used to maintain pools of the resources within set thresholds such that one resource can be exchanged for another at any time.

### BACKGROUND

Computerized digital ledger systems are becoming more desirable for use in a variety of contexts, especially where transactions that may involve resource allocation or transfer need to be completed accurately and quickly. Digital ledger systems may be distributed, such that multiple copies of the ledger are accessed by different entities and different portions or functions of the ledger may be maintained by different entities, but all copies are kept synchronized to reflect the same set of transactions. Digital ledgers may be implemented on a variety of technologies including blockchain and similar storage mechanisms. In many cases digital ledgers are used in conjunction with one or more cryptocurrencies. In general digital ledgers need not be distributed or linked to a specific cryptocurrency.

### BRIEF DESCRIPTION OF THE DRAWINGS

FIG. 1 shows an example process and communication flow for redeeming one resource for another according to an embodiment disclosed herein.

FIG. 2 shows an example process and communication flow for purchasing one resource using another according to an embodiment disclosed herein.

FIG. 3 shows an example process and communication flow for certification of asset backing of one or more resources according to an embodiment disclosed herein.

FIG. 4 shows a process for managing a digital ledger system that supports fixed-value resource units according to an embodiment disclosed herein.

### DETAILED DESCRIPTION

Many digital ledger systems, cryptocurrencies, and related technology do not have a concrete link to real-world, tangible items, systems, or value. For example, although some cryptocurrencies are traded based on pricing that may be set relative to a fiat currency, there is no way that an owner of those cryptocurrencies can be assured that any particular number or value of the cryptocurrency can be exchanged on-demand for a set amount of the fiat currency. As another example, where a digital ledger system is used to allocate computing resource tokens among competing nodes in a distributed network, a participant in the network may have no guarantee that a set level of resource may be obtained by exchanging a set number of allocated tokens at any given point in time. Embodiments disclosed herein may address these and other shortcomings of known systems by using tokens that are have a fixed relationship to a tangible item, such as a resource, currency value, or the like, by using the processes and systems disclosed herein.

In embodiments disclosed herein, a computerized distributed ledger system may support a first resource, such as a token, a tokenized unit of potential computer resource (processor cycles, long-term storage, processing memory, or the like) which may be exchanged on demand for a second type of resource, such as tangible property, actual computing resources used upon request, currency or other recognized store of value, or the like. As described in further detail herein, a system as disclosed herein also may facilitate compliance with a variety of regulatory or other requirements including, but not limited to, Know Your Customer (KYC) and similar rules, Anti-Money Laundering (AML) and similar rules, and general authentication and authorization policies common in distributed and other computing networks.

Generally, embodiments disclosed herein provide for the convenience of using a first resource type, while providing security, confidence, and reliability that may be obtained by backing the first resource type with a second resource type. In some cases, the second resource type may be equally usable as the first, but often may incur additional transaction or processing costs that are not required by the first. In some embodiments, the first resource type also may be exchanged among participants in a distributed ledger system, some or all of which may at any point exchange the first resource for the second. In some embodiments, some participants may be restricted from making such exchanges.

In an embodiment, a computerized distributed ledger system as disclosed herein may be expanded to support the operation of an advertising marketplace. For example, advertising may be delivered to users' digital wallets and users may choose to opt in at one or more levels of participation. For users who choose to opt in, the computerized distributed ledger system may determine and distribute shares of the advertising revenues to the participating users. The distribution and revenue sharing may be implemented in and/or enforced by smart contracts.

In an embodiment, a pool of the second resource may be maintained as an asset backing of the first resource, where the pool is maintained to have a value of the second resource equal to or greater than the value of the first resource that is outstanding within the system. For example, an available pool of actual computing resources may be maintained to account for the number of resource tokens that have been issued to potential users of a cloud computing system, each of which may demand various computing resources at any time based upon the “value” of tokens held by the user. In some embodiments, the first resource may be fixed in value against the second resource, such as in a 1:1 relationship. As a specific example, users of a cloud or other multi-user system may be assigned digital “hosted memory” tokens that can be exchanged for on-demand memory during operation of each user's applications in the cloud system. The memory tokens may be fixed in resource “value” to be equivalent to an equal amount of actual memory available to the user. Smart contracts may be used to ensure that any redemption of a first resource results in an acquisition or distribution of the second resource to maintain the pool of the second resource at an appropriate level.

In an embodiment, a computerized distributed ledger system as disclosed herein may determine whether or not an amount of a second resource that is used to back the first resource is equal to a set requirement which may be user defined or hard-coded into the system, and may output a certification that the requirement is currently being met, or an indication of the amount of any shortfall. In the case of a shortfall, the system also may determine and indicate one or more actions that may be taken, or that the system automatically may take to cure the shortfall. The various resource levels, transactions, and the like may be defined and enforced by one or more smart contracts in the system.

In the event that an excess of asset backing is determined, such as where the pool of the second resource exceeds the amount of the first resource available within the system or otherwise known to be in circulation, the amount of the excess may be distributed to participants in the system, for example as determined by one or more smart contracts. The distribution may be made, for example, by creating additional units of the first resource having a value of the second resource that is at least equal to the determined amount of the excess. For example, where excess storage capacity is available, additional storage tokens may be created and distributed to participants in a multi-user cloud computing system. The participants may later exchange the tokens for actual storage capacity as needed, trade the tokens among themselves, or the like.

In an embodiment, the ubiquitous ability of users to obtain a first resource (which is backed by a second resource) on demand at a fixed “value” relative to the backing second resource may be provided by at least one resource interface node. As described in further detail herein, resource interface nodes (such as GCU interface nodes, infra), may be operated by various entities based upon the relationship of the entity within the distributed ledger system. The specific features and operation methods of a resource interface node may be defined by the operator's role within the system, or by the function that the resource interface node is intended to serve within the distributed ledger system.

In an embodiment, a computerized distributed ledger system as disclosed herein may be a permissioned distributed ledger. For example, an administrative node operated by an administrative entity may be responsible for administering the ledger based on rules and procedures defined within the ledger, for example, based on agreements, government regulations, or other rules governing the operation of the system. The administrative entity operating the administrative node may or may not be an entity also operating one or more other system nodes.

Operationally, a resource interface node may perform functions “off chain” (i.e., outside of the computerized distributed ledger system) as well as “on chain” (within the computerized distributed ledger system) or on a sub-chain of the computerized distributed ledger system. Similarly, linked wallet nodes may record transactions “off chain” as well as “on chain” or on one or more sub-chains of the computerized distributed ledger system. The terms “on chain” and “off chain” are used in the understood context of a blockchain distributed ledger, though it will be understood that the embodiments disclosed herein are not limited to the use of a blockchain implementation. More generally, transactions may be recorded “on chain” or “off chain” based on whether the transaction is recorded on the distributed ledger, regardless of whether the particular transaction or implementation uses a blockchain to record the distributed ledger.

In an embodiment, transactions of the first and/or second resources may be “netted out.” This may be possible because it may be presumed that while some entities within the system are exchanging the first resource for the second, others are doing the reverse. Taking advantage of this potential for “netting out” may enable a significant reduction in the number and frequency of transactions of the backing (second) resource, thereby reducing transaction costs.

Ongoing excesses of redemptions of the first resource by some entities over purchases of the first resource by other entities may lead to holdings of the first resource that exceed desired levels and balances of a second resource that are below desired levels, and vice-versa for ongoing excesses of purchases over redemptions. When the first resource exceeds a desired level, a sufficient amount of the first resource may be transferred or destroyed, so as to bring resource holdings back to a desired level. Similarly, if holdings of the first resource fall below a desired level, a sufficient amount of the resource may be obtained or created so as to bring holdings back to a desired level.

In some embodiments, one or more asset backing interface nodes may be used to allow for netting and/or level-setting of the first and second resources, as described in further detail herein. The asset backing nodes may be operated by the same entities that operate various other nodes within the distributed ledger system, or they may be operated by dedicated asset backing entities. In some embodiments a single asset backing interface node operated by a single asset backing interface entity may be used. Alternatively or in addition, more than one asset backing interface node, which may be operated by more than one asset backing interface entity, may be used.

An example embodiment of the methods and systems disclosed herein will now be described in which a computerized distributed ledger system supports a first resource of digital monetary units (DMU) which may be linked to a second resource including one or more governmental currency units (GCU) such as fiat currencies. In this example, the DMU may include a unique combination of attributes that include offering users a combination of lower costs and real-time transaction speeds while providing a safe, fixed-price store of value, redeemable on demand in GCU. As previously disclosed, a computerized distributed ledger system as disclosed herein also may facilitate compliance with a variety of governmental/societal objectives, including, but not limited to, Know Your Customer (KYC) and Anti-Money Laundering (AML). These features also may provide users of the DMU and/or the institutions operating a DMU computerized distributed ledger system with improved protections against fraud and other problems.

As previously indicated, in an embodiment, a computerized distributed ledger system as disclosed herein may be expanded to support the operation of an advertising marketplace. For example, advertising may be delivered to users' digital wallets and users may choose to opt in at one or more levels of participation. For users who choose to opt in, the computerized distributed ledger system may determine and distribute shares of the advertising revenues to the participating users. The distribution and revenue sharing may be implemented in and/or enforced by smart contracts.

Attributes of a DMU supported by a computerized distributed ledger system disclosed herein may include some or all of the following features, each alone or in any combination:

Asset backing determined by smart contracts incorporated into the computerized distributed ledger system and enforced by processes incorporated into the software of the computerized distributed ledger system and nodes of the ledger system—including, but not limited to, an asset backing interface computer system node and at least one GCU interface computer system(s) node(s);

A fixed price for the DMU coded into the computerized distributed ledger system and;

A process for determining a current amount of the fixed price in one or more GCUs; and,

A ubiquitous ability of users of the DMU to redeem/purchase DMU on demand by receiving/using GCU at the fixed price in GCU or the current determined amount of the fixed price in GCU.

In an embodiment, the asset backing may be a pool of prime money fund assets with a value in GCU equal to or greater than the value of the outstanding DMU in GCU. The fixed price of a DMU may be set equal to one GCU. For example, where the DMU is a standardized token, the value of one token may be set equal to $1.00 USD. Other fixed relationships may be set between a DMU and a tangible resource, such as a GCU or other resource. The asset backing may be a combination of government money market funds and/or short-term Treasury securities or the like, or any other central-bank liabilities. The asset backing may be held in a regulated Trust company.

In an embodiment, a feature of the distributed ledger computer system may be the use of smart contract(s) and/or other associated process(es) that may ensure that a net purchase or other redemption of DMU results in the purchase/sale of assets backing the DMU with a value in GCU equal to the value in GCU of the net amount of DMU purchased/redeemed. The amount of the net purchase/redemption of DMU is equal to the increase/decrease in the amount of DMU outstanding.

In an embodiment in which multiple GCU interface computer systems and an asset backing interface computer system are used, the process of matching purchased DMU to backing resource GCU may be multi-level, beginning with GCU interface nodes that enable DMU users to purchase/redeem DMU on demand at the fixed price and ending with the asset backing interface node. In this arrangement, the asset-backing interface node may execute one or more net purchase and/or redemptions that increase or decrease the amount of DMU outstanding as appropriate.

The use of one asset backing interface node may reduce the frequency and associated processing and transaction costs of purchases and sales of assets backing the DMU. However, in some embodiments multiple asset backing interface nodes may be used.

In an embodiment, a computerized distributed ledger system as disclosed herein may include a smart contract or contracts requiring regular (e.g., hourly, daily, weekly, etc.) determination of the current value in GCU of the assets backing the DMU and a comparison of this value to the current value in GCU of the outstanding DMU. The computerized distributed ledger system may then further determine whether or not the amount of the asset backing is equal to a set requirement which may be user defined or hard-coded into the system, and may output a certification that the requirement is currently being met, or an indication of the amount of any shortfall. In the case of a shortfall, the system also may determine and indicate one or more actions that may be taken, or that the system automatically may take to cure the shortfall as specified by the smart contract(s) built into the computerized distributed ledger system.

As previously disclosed, in an embodiment may use asset backing by a pool of prime money market fund assets or other assets and may fix the price of a DMU fixed at a set value of GCU, such as $1.00. For example, a cryptocurrency may be managed by the system to maintain the value of a single unit of the cryptocurrency at a specific value of a fiat currency. As a specific example, one unit of the cryptocurrency may be fixed by managing pools of the cryptocurrency and the fiat currency or other equivalent value such that a unit of the cryptocurrency may always be exchanged by a participant in the system for a known, set value of the fiat currency. In such an embodiment, the system may include a requirement to maintain asset backing equal in value to the number of DMU outstanding. In another preferred embodiment, a similar requirement may be to maintain asset backing equal to the value of the number of DMU outstanding at their current price in GCU, plus a margin determined by the smart contract(s), which may be a function of specified variables, including (but not limited to) variables for estimating the interest rate risk and/or credit risk of the assets backing the DMU.

In the event that the system identifies a shortfall of asset backing, one or more smart contracts in the computerized distributed ledger system may enforce actions for remedying the shortfall. Such actions may include, for example, one or more of the following: 1) ceasing payout of the investment earnings of the assets backing the digital monetary units until the shortfall is remedied; and, 2) an assessment against the DMU held by participating (in the computerized distributed ledger system) institutions, reducing those holdings by an amount that is a function of the determined shortfall. Other actions may be used.

In the event that an excess of asset backing is determined (e.g., as the result of investment earnings of the assets), the amount of the excess may be paid out in a manner determined by one or more smart contracts in the computerized distributed ledger system. In an embodiment, these payouts are made in the form of newly created DMU with a value in GCU equal to the determined amount of the excess—thus bringing the value in GCU of the outstanding number of DMU into equality with the required value in GCU of assets backing as determined by the smart contract(s) coded into the computerized distributed ledger system.

In an embodiment, smart contracts built into the computerized distributed ledger system may specify that distributions of excess asset holdings (e.g., resulting from investment income, including gains and losses) are to be made only to participating (in the computerized distributed ledger system) institutions (e.g., participating depository institutions, a payments system institution managing digital wallets that do not include a GCU interface, the institution operating the asset backing interface node, etc.), with the amount of a distribution being determined as a function of the amount of DMU held by the institution and its customers (e.g., for a participating depository institution, the number of DMU held by the digital wallet of the depository institution and the GCU account linked wallets of its depositors). This embodiment may enable lower, transaction fees for users to the extent that investment earnings may replace income from transaction fees. In other embodiments, the smart contract(s) may distribute investment income to all holders of DMU in accordance with their holdings of DMU (and other possible factors).

In an embodiment, smart contracts built into the computerized distributed ledger system may specify distributions of system fees (e.g., transactions fees, fees for implementing and/or maintaining smart contracts, etc.) to the institutions comprising the system (e.g., participating depository institutions, a payments system institution managing digital wallets that do not include a GCU interface, the institution operating the asset backing interface node, etc.) on a gross (before system operating expenses) and/or a net (after system operating expenses) basis. In a variation of this embodiment, transactions fees may be limited to one or more types of transactions—e.g., the receipt of DMU from purchasers of goods and services by digital wallets owned by merchants.

In some embodiments, the ability of a computerized distributed ledger system as disclosed herein to maintain and certify the required asset backing may be used to encourage user confidence in the ability to redeem users' holdings of DMU on demand for GCU at the fixed price of the DMU. In some cases such confidence may be desirable or necessary for the computerized distributed ledger system to maintain the fixed price and the functionality of the system. This follows because the GCU (e.g., U.S. dollars) required to fund a net redemption of DMU are generated by the sale of assets backing the DMU with a value in GCU equal to value in GCU of the amount of the net redemptions at the fixed price of the DMU. If the value in GCU of the assets backing the DMU falls below the value of the value in GCU of the outstanding number of DMU at the fixed price, users may lose confidence in the ability of the computerized distributed ledger system to maintain the fixed price of the DMU, causing a run on the system as holders of DMU rush to redeem before the fixed price collapses due to inability of users to redeem DMU for GCU at the fixed price.

In an embodiment, the smart contract governing the price of the DMU fixes the price of a DMU at one GCU (e.g., $1.00 US). In another embodiment, the smart contract governing the price of a DMU fixes the price at one unit of constant purchasing power as defined within the smart contract (e.g., one UDI, a measure of constant purchasing power calculated and published by the central bank of Mexico). In such a case, the smart contract may include a lookup function to access the current data with respect to the purchasing power measure (e.g., looking up the current UDI index value as published by the central bank of Mexico) and then using the data to determine a current price of the DMU in GCU (e.g., the current price of the DMU in Mexican pesos).

In an embodiment, the ubiquitous ability of users to redeem/purchase DMU on demand at the determined price of the DMU in GCU may be provided by at least one GCU interface node. The wider the reach and the greater the access to these GCU interface nodes, the more ubiquitous the ability of users to redeem/purchase DMU and, therefore, the greater the potential utility of DMU. The computerized distributed ledger system is designed to support a large number, and variety, of GCU interface nodes, thus maximizing the ubiquity of users' ability to redeem/purchase DMU on demand and the functionality of the system.

GCU interface nodes may be implemented, maintained, and/or offered by depository institutions—e.g. commercial banks, savings banks, credit unions, or the like. In this case, the ability to purchase/redeem on demand may be implemented by customers of the depository institution using digital wallets linked to one or more GCU deposit accounts that the user holds in the institution. In this case the KYC requirements applying to the computerized distributed ledger system may be satisfied by the KYC procedures applied by the institution to new customers opening deposit accounts in the institution. The deposit-linked digital wallets may be managed by a GCU linked wallet node wherein the GCU linked wallet node may be a computer system operated by the depository institution itself or by a third party performing contractual services for the depository institution.

Similarly, GCU interface nodes may be offered by broker/dealers offering customers GCU transactional accounts and the ability to link to these transactional accounts using a GCU linked digital wallet. Again, KYC requirements applying to the computerized distributed ledger system may be satisfied by KYC procedures applied by the broker/dealer during the process of establishing customer accounts and the account linked digital wallets may be managed by a GCU linked wallet node wherein the GCU linked wallet node computer system may be operated by the broker/dealer itself or by a third party performing contractual services for the broker/dealer.

GCU interface nodes may also be offered by one or more institutions managing ATM networks designed to transact in DMU in addition to GCU. As in the case of a GCU interface node offered by a depository institution or a broker/dealer, the institution(s) offering GCU interface node(s) and ATM network(s) transacting in DMU in addition to GCU may be responsible for maintaining and operating effective KYC and AML practices.

Not all potential users of DMU for transactions may have access to, or desire the use of, GCU linked digital wallets. Accordingly, to accommodate the needs/desires of these potential DMU users, in an embodiment the computerized distributed ledger system may include a payment systems node operated by a payment systems entity offering DMU only digital wallets to these potential users. In a variation of this embodiment, institutions offering GCU linked wallets may offer DMU only digital wallets in addition to GCU linked digital wallets. As with the GCU interface nodes, the institution offering the payment systems node may be responsible maintaining and operating effective KYC and AML practices.

In an embodiment, rules coded into the computerized distributed ledger system limit DMU transactions—both payments and receipts—to digital wallets (both GCU linked and DMU only) offered by institutions maintaining and operating effective KYC and AML practices. In a variation of this preferred embodiment, the computerized distributed ledger system may include systems drawing on network transactions data in order to further improve the KYC and AML compliance of the computerized distributed ledger system.

Limiting DMU transactions to digital wallets owned by known persons and entities may also assist in protecting both DMU users and the institutions operating the computerized distributed ledger system from losses caused by fraud as it is expected that the system will know the origin and recipient of every DMU transaction (in the absence of KYC failure).

In an embodiment, the computerized distributed ledger system is a permissioned distributed ledger. A variation of this embodiment includes an administrative node operated by an administrative entity charged with administering the permissioned distributed ledger system according to rules and procedures set down in the code of the computerized distributed ledger system and/or the agreements governing the operation of the system. The administrative entity operating the administrative node may (or may not) be an entity also operating one or more other system nodes—e.g., the administrative entity may also be the entity operating the asset backing interface node and/or an administrative entity operating the digital infrastructure manager node.

In an embodiment, the computerized distributed ledger system may include a wallet operating systemnode operated by an entity that develops, maintains and upgrades wallet operating systems for both GCU linked and DMU only digital wallets. Maintaining a common operating system for all digital wallets may enable the computerized distributed ledger system to support additional features such as an advertising marketplace for ads (including coupons and special offers) delivered to the digital wallets of users who opt into the marketplace and, in return, receive a share of advertising revenues as per smart contract(s) built into the computerized distributed ledger system.

For many users, a GCU interface node offered by a depository institution (e.g., a commercial bank, a savings bank, or credit union) may provide the most convenient interface between their holdings of GCU and DMU. For others (e.g., investors), a GCU interface node offered by a broker/dealer may be most attractive. For still others, a GCU interface node may be offered by a computer system administering a network of ATMs, or by a computer system administering check cashing businesses, etc., may be most attractive.

For the un-banked and/or under-banked, a digital wallet offering a GCU interface may be unattainable and/or not desired. However, DMU digital wallets without GCU interfaces, offered by at least one payments system node and/or by institutions also offering digital wallets with GCU interfaces may allow the un-banked and/or under-banked to participate in the benefits of the system.

Regardless of the institution with which a GCU interface node is associated, the GCU interface node may be operated by a separate computer system (possibly owned and operated by an entity other than the entity providing the GCU interface node) interacting with one or more computer systems that administer the operations of the institution or it may be operated by one of the computer systems that administer the operation of the institution. For example, in an embodiment, depository institutions are among the institutions offering GCU interface nodes and the computer system(s) of the depository institution or an agent of the depository institution may create the interface by linking depositor accounts to the digital wallets of the institution's depositors. Examples of institutions that may operate agent computer systems include institutions that presently manage on-line banking for depository institutions seeking to outsource this function. In this preferred embodiment, the account linked digital wallets used by depositors (the GCU linked wallet node) may be operated by the depository institutions—or the agents the depository institution may contract with for digital wallet management services.

Alternatively or in addition, an entity operating a network of ATMs provides the interface services (i.e. the purchase of DMU using GCU and the redemption DMU in GCU) while the GCU interface node, together with the associated GCU linked wallet node, is owned and operated by a wallet-management entity (which may or may not be owned by the same entity that owns and operates the ATM network) of the computerized distributed ledger system.

As previously disclosed with respect to general resource interface nodes, a GCU interface node may perform functions “off chain” (i.e., outside of the computerized distributed ledger system) as well as “on chain” (within the computerized distributed ledger system) or on a sub-chain of the computerized distributed ledger system. Similarly, GCU linked wallet nodes may record transactions “off chain” as well as “on chain” or on one or more sub-chains of the computerized distributed ledger system.

In an embodiment, all DMU transactions are carried out using the computerized distributed ledger system (on chain) and the GCU accounts transactions accessed by users to purchase DMU and to receive proceeds from the redemption of DMU are off chain—e.g., in an embodiment in which depository institutions' computer systems (and/or an agent computer system) are the GCU interface computer system. However, in other embodiments, portions of the DMU transactions may be carried out off chain (and/or on sub-chains) and portions (or all) of the GCU accounts may be administered on chain (and/or on sub-chains).

In an embodiment, GCU interface computer system(s), acting alone or together with other computer systems administer a process of “netting out” the purchases and redemptions of the DMU by customers of the institution providing the GCU interface. This “netting out” is possible because when some customers are redeeming DMU for GCU, other customers are—or soon will be—using some of their GCU account funds to purchase DMU. Due to timing differences, implementing this netting out process requires the institution to hold a “buffer amount” of DMU in a GCU linked wallet owned by the institution and operated by a GCU interface wallet node.

Taking advantage of this potential for “netting out” may enable a significant reduction in the number and frequency of sales and purchases of the assets backing the DMU, thus reducing asset management (and system management) costs. In this “netting out” process, the institution offering the GCU interface node maintains an inventory of DMU in its (the institution's) own digital wallet, together with an inventory of GCU in a clearing account. Temporary excess of redemptions over purchases by the customers of the institution are met by drawing down the inventory of GCU held by the institution in its clearing account and simultaneously increasing the number of DMU held in the institution's digital wallet and vice-versa for temporary excesses of purchases over redemptions by the institution's customers.

Ongoing excesses of redemptions over purchases by an institution's customers may lead to holdings of DMU in the institution's digital wallet that exceed desired levels and balances of GCU in the institution's clearing account that are below desired levels, and vice-versa for ongoing excesses of purchases over redemptions by the institution's customers. In some embodiments, when DMU holdings in the institution's digital wallet come to exceed desired levels and, as a result GCU holdings in the institution's clearing account fall below desired levels, the institution may choose to redeem a sufficient number of DMUs so as to bring DMU holdings in the institution's digital wallet back to a desired level, which will in turn create a GCU inflow into the institution's clearing account, returning the balance in this account to a desired level. If DMU holdings in the institution's digital wallet fall below desired levels and, as a result GCU holdings in the institution's clearing account rise above desired levels, the institution may choose to purchase a sufficient number of DMU so as to bring holdings in the institution's digital wallet back to a desired level, which will in turn create a GCU outflow from the institution's clearing account, returning the balance in this account to a desired level.

In an embodiment, an asset backing interface node, operated by an asset backing interface entity, acting alone or together with other computer systems administers a process of “netting out” the purchases and redemptions of DMU by the institutions providing the GCU interfaces. This “netting out” is possible because when some institutions are redeeming excess holdings of DMU in return for replenishing the holdings of GCU in their clearing accounts to desired levels, other institutions are—or soon will be—using some of the excess GCU holdings in their clearing accounts to purchase DMU in order to replenish their holdings of DMU in their digital wallets to desired levels. Due to timing differences, implementing this netting out process requires the asset backing interface institution to hold a “buffer amount” of DMU in a GCU linked wallet owned by the asset backing interface institution and operated by a GCU interface wallet node.

Ongoing excesses of redemptions over purchases by the GCU interface institutions may lead to holdings of DMU in the asset backing interface institution's digital wallet that exceed desired levels and balances of GCU in the asset backing interface institution's clearing account that are below desired levels, and vice-versa for ongoing excesses of purchases over redemptions by the GCU interface institutions. When DMU holdings in the asset backing interface institution's digital wallet come to exceed desired levels and, as a result GCU holdings in the asset backing interface institution's clearing account fall below desired levels, the institution may choose to redeem/destroy a sufficient number of DMUs so as to bring DMU holdings in the asset backing interface institution's digital wallet back to a desired level. For example, the asset backing interface institution may implement this redemption/destruction by ordering the asset manager to sell assets with a value equal to the value of the DMU being redeemed/destroyed. Upon receipt by the asset backing interface's clearing account of the sale proceeds (in GCU) from the redemption/destruction of DMU, the asset backing interface institution reduces the DMU holdings in its digital wallet by the amount of DMU redeemed/destroyed, which in turn reduces the total amount of DMU outstanding by the amount of DMU redeemed/destroyed.

If DMU holdings in the asset backing interface institution's digital wallet fall below desired levels and, as a result GCU holdings in the asset backing institution's clearing account rise above desired levels, the asset backing institution may choose to purchase/create a sufficient number of DMU so as to bring DMU holdings in the asset backing interface institution's digital wallet back to a desired level. The asset backing interface institution implements this purchase/creation by ordering the asset manager to purchase assets with a value equal to the value of the DMU being purchased/created. Upon payment from the clearing account of the asset backing interface institution to the asset manager equal the value in GCU of the DMU to be purchased/created, the asset backing interface institution increases the DMU holdings in its digital wallet by the amount of DMU purchased/created, which in turn increases the total amount of DMU outstanding by the amount of DMU purchased/created.

Although a single asset backing interface node operated by a single asset backing interface entity is an embodiment, other embodiments may employ more than one asset backing interface node operated by more than one asset backing interface entity.

An additional feature of the computerized distributed ledger system may be a requirement, enforced through certification processes, that all wallet owners (both GCU linked wallets and DMU only wallets) satisfy Know Your Customer (KYC) requirements. In embodiments that include this feature, DMU may not be sent to or received from, digital wallets whose owners have not been KYC certified.

In an embodiment, the computerized distributed ledger system is a permissioned distributed ledger system, configured so as to allow law enforcement and regulators access to whatever data to which they have demonstrated legal authority for access. This together with processes certifying that all users of digital monetary units have been KYC certified enhances determinations of users compliance with regulations, in addition to assuring system compliance and Anti-Money Laundering (AML) and KYC requirements. The ability to link all participants in a transaction with KYC certified identities may also enhance fraud protection for both users and participating institutions.

In an embodiment, the computerized distributed ledger system includes at least one digital wallet management node operated by at least one digital management computer system. In a variation of the embodiment, each institution operating—either itself or outsourced to an agent computer system—a GCU interface node (e.g., depository institutions offering GCU account linked digital wallets) and each institution operating—either itself or outsourced to an agent computer system—a payments management computer system (e.g., institutions offering DMU only digital wallets) may operate its own digital wallet management computer system—either itself or outsourced to an agent computer system.

In an embodiment, all digital wallet management computer systems are operated by trusted institutions who may be system certified. As trusted institutions, they may follow (system) certified practices for holding and protecting the private keys of the digital wallets that they are managing. Certified practices may include generation of single-use tokens for carrying out transactions authorized by wallet owners.

An embodiment may further include a digital infrastructure management node operated by an administrative institution charged with maintaining (and updating) the interoperability and functionality of the computerized distributed ledger system. This computer system may include digital wallet operational systems management computer system whose function is to provide and upgrade an underlying digital wallet operating system used by every wallet operated by every digital wallet management computer system in a manner analogous to which an Android operating system computer system provides and upgrades the Android operating system of every Android smartphone.

Alternatively or in addition, the digital infrastructure management computer system may support and enable a digital advertising marketplace computer system enabling the operation of an advertising marketplace based upon the digital wallets for the digital monetary units wherein users may choose to opt in and, if so, receive shares of the revenues generated by the marketplace defined by “smart contracts” coded into the computerized distributed ledger system and enforced by certification processes built into the computerized distributed ledger system.

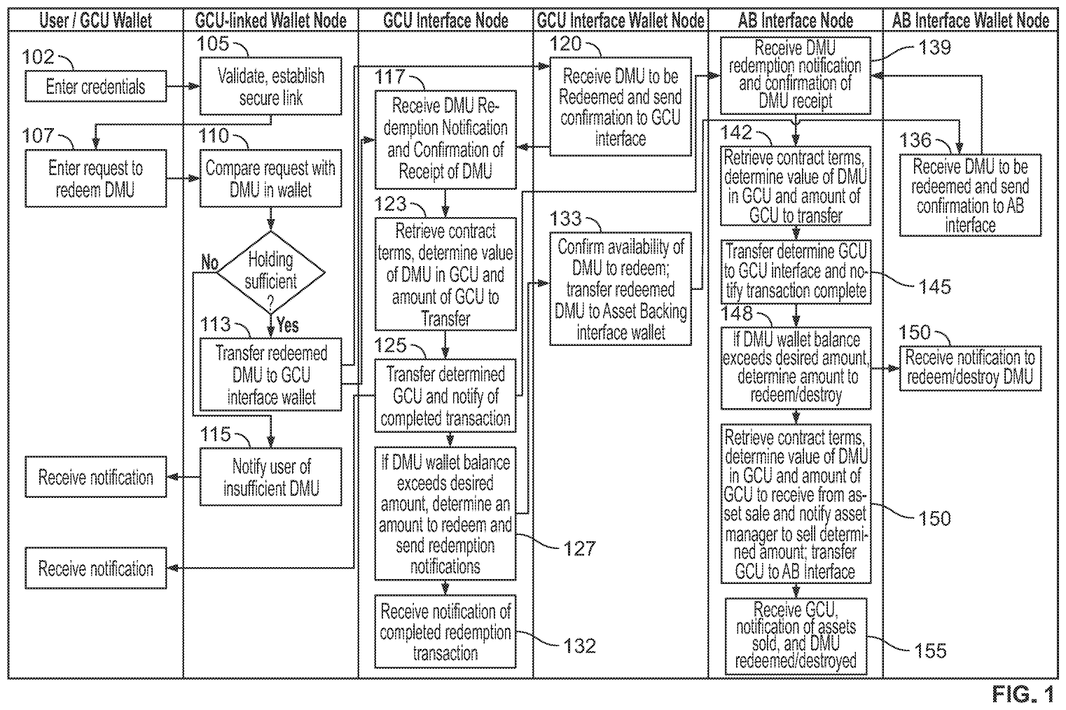

FIG. 1 shows an example process and communication flow for redemption of one resource for another according to the present disclosure. Continuing the examples provided above, the process may be used to redeem DMU for GCU at equal or equivalent values. As previously disclosed, the system may maintain a pool of one or both resources so that such a redemption may be carried out at any time by any participant in the system. The example processes described herein show a variety of entities, including a user that owns a GCU wallet; a GCU-linked wallet node; a GCU Interface node and GCU Interface wallet node, which may be operated by, for example, a bank or similar institution; and an Asset Backing (AB) Interface node and Asset Backing Interface wallet node, which may be operated by an entity that provides asset backing as disclosed herein. The specific division of functionality shown in the present examples is illustrative only, and various functions may be performed by one or more physical computer systems, which may operate in conjunction, or in a common environment such as a cloud environment, or may operate independently. For example, a single service may provide the user's GCU wallet and the GCU-linked wallet node and/or GCU Interface node, or each may be provided by a separate entity.

At 102, the user begins the process by entering credentials to access the user's GCU wallet. The GCU-linked wallet node validates the user's credentials at 105. At 107, the user may perform various functions with regard to the GCU wallet, such as requesting redemption of a specific number or value of DMU owned by the user. As a specific example, the user may wish to exchange a value or number of cryptocurrency units owned by the user for an equivalent value of fiat currency or other value-bearing item as disclosed herein. At 110, the GCU-linked wallet node compares the request with the DMU in the user's wallet. If the user's holdings are sufficient for the requested transaction, the node transfers the requested DMU to the GCU interface wallet at 113. Otherwise the node notifies the user of insufficient holdings at 115 and ends the process.

If the redeemed DMU are transferred to the GCU interface wallet at 113, the GCU interface node may receive a notification of the DMU redemption and/or a confirmation of receipt of the DMU by the GCU Interface wallet node at 117; concurrently or sequentially, the GCU Interface wallet node may receive the DMU to be redeemed and provide the redemption confirmation to the GCU Interface node at 120.

Continuing operations at the GCU Interface node, at 123 the node may retrieve contract terms associated with the user's account, the asset-backed system, or other aspects of the transaction. The terms may be embodied, for example, in one or more smart contracts, or may be implemented as rules within the system. Unless indicated to the contrary, references to “contract terms” in the examples provided herein and shown in FIGS. 1-3 may use equivalent rules and policies, which may or may not be implemented in one or more smart contracts within the system. The node also may determine the value of DMU being redeemed in GCU, and the associated amount of GCU to transfer at 123. At 125, the node may transfer the determined amount of GCU and notify the user of the completed transaction. The node also may determine if the DMU wallet balance exceeds the desired amount, in which case the node may determine an amount of DMU to redeem and send appropriate notifications to the GCU Interface wallet and AB Interface nodes as shown at 127, receiving a notification of the completed redemption transaction(s) at 130. Upon receipt of such a notification at 133, the GCU Interface wallet node may confirm the availability of the DMU to be redeemed, and transfer the redeemed DMU to the AB Interface wallet at 133. At 136 the AB Interface wallet node receives the DMU to be redeemed and sends a confirmation to the AB Interface node, which receives the redemption notification and confirmation of receipt at 139.

After receiving the redemption notification and DMU receipt confirmation at 139, at 142 the AB Interface node may retrieve the appropriate contract terms to determine the value of DMU in GCU, and the associated amount of GCU to transfer. The AB Interface node also may transfer the determined amount of GCU to the GCU Interface node at 145 and provide a notification that the transaction is complete.

At 148, the AB Interface node determines if the resulting DMU wallet balance exceeds the desired amount and, if so, an amount of DMU to redeem or destroy, for example to maintain an appropriate pool of each resource as disclosed herein. If necessary, the AB Interface wallet node may be notified at 150 of the amount of DMU to redeem or destroy.

At 151, the node may determine the value of DMU in GCU and the amount of GCU to receive from an asset sale by an asset manager as disclosed herein. The node then may notify the asset manager to sell the determined asset value or amount, and transfer the associated GCU to the AB Interface node.

At 155, the node receives the GCU, a notification of any assets sold, and/or a notification of DMU redeemed or destroyed, according to the previous transactions.

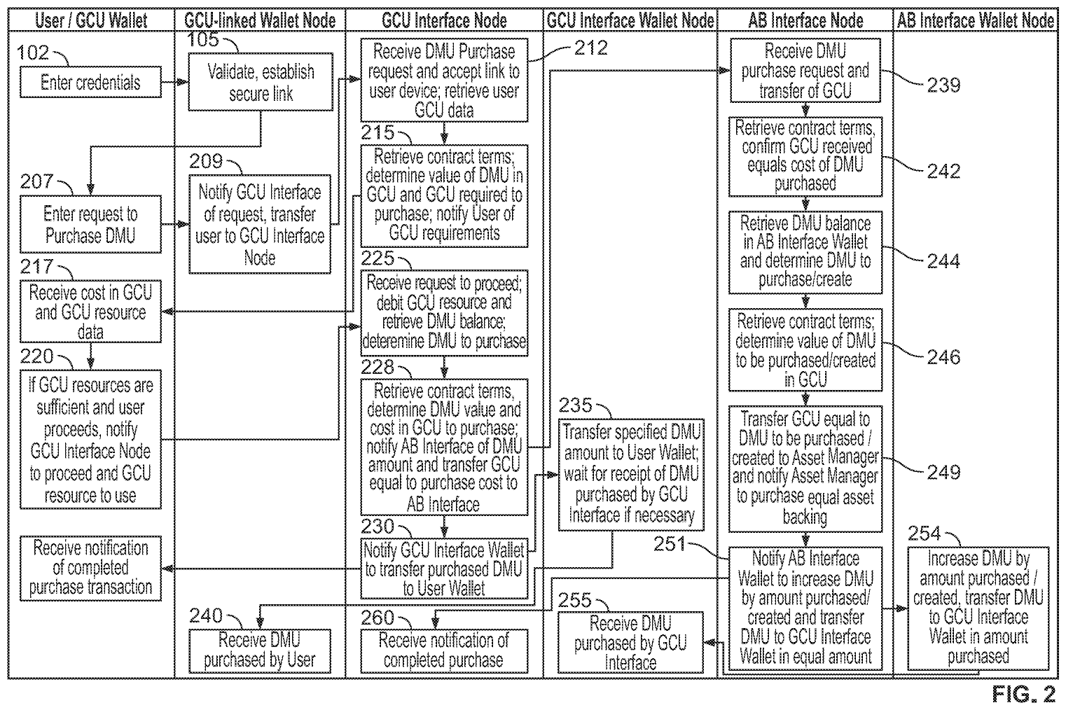

FIG. 2 shows a similar process with the same illustrative entities, for purchasing DMU by a user. For example, the process in FIG. 2 may be used where a user desires to purchase a specific amount or value of a cryptocurrency within an asset-backed and normalized system as disclosed herein. At 102 and 105, the user may provide credentials and establish a secure communication link as previously disclosed, after which the user may enter a command or request to purchase a desired amount or value of DMU at 207.

At 209, the GCU-linked wallet node notifies the GCU Interface node of the request and transfers the user's communication session to the GCU Interface node which then retrieves the user's GCU account data at 212 to determine whether there is sufficient value of GCU in the account to transfer for the desired amount or value of DMU. At 215, the node may retrieve contract terms (or other rules as previously disclosed) and determine the value of desired DMU in GCU. The node then may notify the user of the requirement at 217. If the GCU resources are sufficient and the user decides to proceed at 220, the user or the user's device may notify the GCU Interface node to proceed and confirm the GCU resources to use for the transfer.

The GCU Interface node receives the request at 225 and debits the GCU resource from the appropriate account. It also may retrieve the user's DMU balance and determine the number or value of DMU to purchase based upon the request.

At 228, the node may retrieve any relevant contract terms and determine the DMU value and cost in GMU for the DMU to be purchased. The node also may notify the Asset Backing (AB) Interface node of the requested DMU amount and transfer an amount of GCU equal to the purchase cost to the AB Interface node. At 230, the node may notify the GCU Interface wallet to transfer the purchased DMU to the user's wallet.

In response, at 235, the GCU Interface wallet node may transfer the specified DMU amount to the User wallet node for receipt at 240 and, if necessary, await receipt of the DMU purchased by the GCU Interface node.

Returning to 228, the GCU Interface node also may notify the AB Interface node of the DMU purchase request and the GCU transfer, which is received by the AB Interface node at 239. The AB Interface node may retrieve relevant contract terms at 242 and confirm that the received GCU is equivalent in value to the value of DMU purchased. At 244, the node may retrieve the balance in the AB Interface wallet and determine the value of DMU to purchase and/or create as disclosed herein. At 246, the node may retrieve any relevant contract terms for the transaction and determine the value of DMU to be purchased and/or created as determined at 244 in GCU.

At 249, the node may transfer a value of GCU equal to the DMU to be purchased and/or created to an Asset Manager and notify the Asset Manager to purchase equal asset backing in an equal amount. The node may notify the AB Interface wallet to increase the DMU by the amount purchased and/or created, and transfer the DMU to the GCU Interface wallet in an equal amount at 251. At 254, the AB Interface wallet node may increase the held DMU by the amount purchased and/or created, and transfer DMU to the GCU Interface wallet in the amount purchased, which is received at 255.

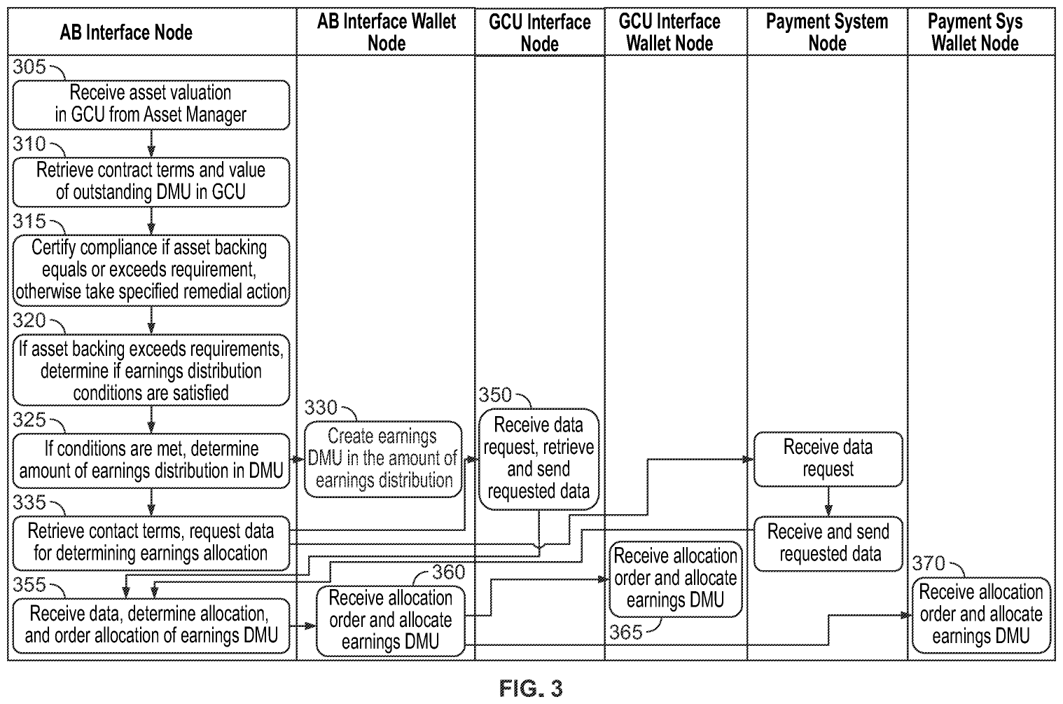

As previously described, embodiments disclosed herein may allow for maintaining a pool of assets that back one or more resources. FIG. 3 shows an example process for asset backing certification and earnings distribution, again using a DMU/GCU-based system as described with respect to FIGS. 1 and 2. An Asset Backing computer system, such as an Asset Backing interface node as previously disclosed, may manage such a process. At 305, the node may receive an asset valuation in GCU from an Asset Manager, such as disclosed with respect to FIGS. 1 and 2. At 310, the node may retrieve relevant contract terms and the value of outstanding DMU in GCU.

At 315, the node may certify compliance with the asset backing requirements if the value of backing assets equals or exceeds a set requirement for the system. Otherwise the contract terms may specify remedial action, such as instructing the Asset Manager to purchase or sell additional asset backing. If the asset backing exceeds the set requirements, the node next may determine if one or more earnings conditions are satisfied at 320. The asset backing requirements and/or the earnings conditions may be predefined within the system or may be specified by external rules, regulations, or the like.

At 325, the node may calculate the amount of earnings distribution in DMU if the compliance and asset backing requirements are met, resulting in the AB Interface wallet node creating earnings DMU in the determined amount at 330. Continuing from 325, the Asset Backing interface node may retrieve contract terms and required data for determining the earnings allocation at 335. Data may be obtained from the GCU Interface node at 350 and received by the AB interface node. As a result, at 355, the AB Interface may determine the allocation and order the determined allocation of earnings DMU to the AB Interface wallet node, which allocates the determined earnings at 360. The data may be obtained from the GCU Interface node and/or a Payment System node as shown, in response to prior requests. At 365 and 370, the GCU Interface wallet node and/or the Payment System wallet node, respectively, may receive the allocation order generated at 360 and allocate the earnings DMU.

Although examples provided herein are given in terms of DMU and GCU, it will be understood that equivalent features may be used with any suitable types of resources and such features are not limited to the specific DMU/GCU example. For example, the processes and communications in FIGS. 1, 2 and 3 are shown and described with respect to DMU and GCU transactions, but will apply equally to any management of first and second resources as disclosed herein, where the first resource is backed at a set rate by the second resource.

Some features and functions disclosed herein are described in the context of an entity taking an action or choosing to take an action. For example, various institutions may choose to adjust the levels of DMU and GCU held. Unless specifically indicated to the contrary, it will be understood that such actions may be taken automatically based upon rules in each entity's computerized systems and may not require any human intervention or decision to process. For example, systems as disclosed herein may automatically adjust the levels of DMU held by an entity, based upon rules defined by the individual entity, a distributed ledger in which the entity records transactions or otherwise participates, a joint venture between the entity and other entities, government regulatory requirements, or the like.

Embodiments disclosed herein may include any of the following features, in any suitable combination or arrangement within one or multiple embodiments:

A system for and/or a method of maintaining a digital ledger, wherein a first resource is backed by a second resource. The first resource may be set to have a particular value or other relationship relative to the second resource, such as where one unit of the first resource is set to be equivalent to one unit of the second resource. The first resource may be, for example, a token, a representation of usable computing resources, a unit of cryptocurrency, or the like. The second resource may be, for example, a fiat currency, tangible property, actual used computing resources, or the like.

One or more pools of the first resource may be managed to maintain a desired level of the first resource relative to the second resource. The management may include obtaining or creating additional units of the first resource in the event of a shortfall relative to a desired amount. The management may include destroying or transferring to a different entity units of the first resource in the event of a surplus of the first resource relative to the desired amount. The management of the resource pools may be performed automatically based upon rules in a digital ledger system.

One or more pools of the second resource may be managed to maintain a desired level of the second resource relative to the first resource. The management may include obtaining additional units of the first resource in the event of a shortfall relative to a desired amount. The management may include transferring to a different entity units of the second resource, optionally for units of the first resource, in the event of a surplus of the second resource relative to the desired amount. The management of the resource pools may be performed automatically based upon rules in a digital ledger system.

One or more pools of the second resource may be managed to maintain a desired level of the second resource relative to the first resource. The management may include obtaining, according to the desired relationship with the first resource, additional units of the second resource in response to an increase in the desired level of the first resource, optionally creating units of the first resource in accordance with the desired increase in the first resource. The management may include transferring to a different entity units of the second resource, according to the desired relationship with the first resource, in response to a decrease in the desired level of the first resource, optionally destroying units of the first resource in accordance with the desired decrease in the first resource.

Rules in the digital ledger system may be embodied in, and/or enforced by, one or more smart contracts within the digital ledger system.

The pools of resources managed by one or more entities may be controlled such that the first resource is always exchangeable by one, some, or all participants in the system for a known amount, value, or equivalent of the second resource.

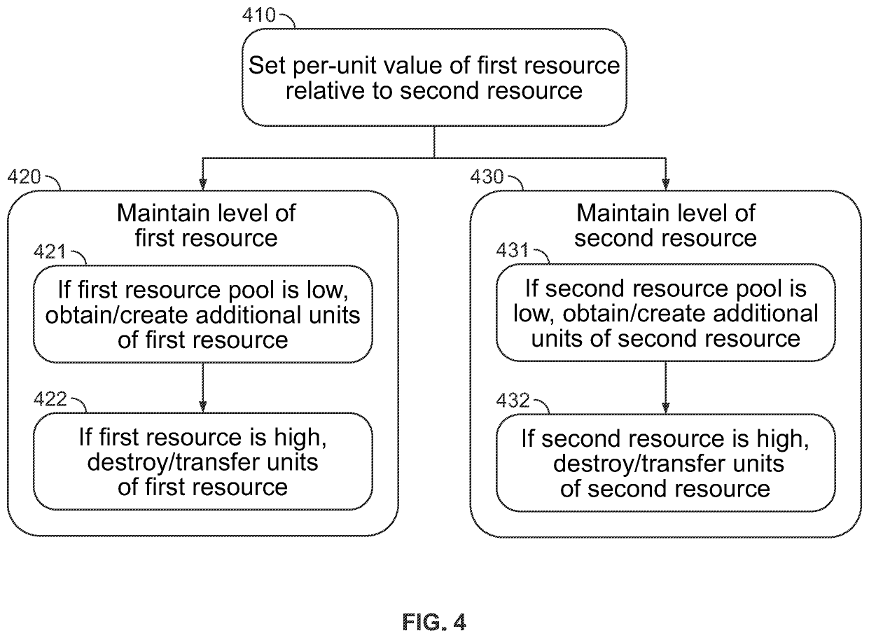

FIG. 4 shows an example process for managing such resource pools in accordance with embodiments as disclosed herein. At 410, the relative values of two resources may be set. The relative value may be set using any of the various techniques disclosed herein, such as through the use of one or more markets, or by artificially setting a specific relative value such as where one unit of a cryptocurrency is set to be equal to one unit of a fiat currency, other cryptocurrency, or other unit of value. The first and second resource pools may be maintained at 420 and 430, respectively. For example, the amount of the first resource in the pool may be maintained between upper and lower boundaries by obtaining and/or creating additional units when the first pool is low (i.e., below a set threshold value) at 421, and/or destroying and/or transferring units to another owner when the first pool is high (i.e., above an upper threshold value) at 422. Similarly, the second resource pool may be maintained using equivalent adjustments at 431, 432, respectively.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

Various embodiments of the subject matter disclosed herein may include and/or may be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose processor, the computer program code segments configure the processor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

1. A method of maintaining a digital ledger in which a first resource is backed by a second resource and exchangeable for the second resource at a set per-unit value, the method comprising:
setting the per-unit value of a first resource managed by the digital ledger relative to a second resource;
maintaining at least two interface nodes where the first resource is exchangeable for the second resource at the set per unit value;
maintaining a desired level of the first resource relative to the second resource by:
responsive to a determination that a pool of the first resource is below a first threshold value, obtaining or creating additional units of the first resource based upon one or more rules in the digital ledger; and
responsive to a determination that the pool of the first resource is above a second threshold value, destroying or transferring units of the first resource based upon one or more rules in the digital ledger.

2. The method of claim 1, wherein each of the at least two interface nodes provide an interface to the pool of the first resource.

3. The method of claim 1, wherein the at least two interface nodes net exchanges of the first resource for the second resource against exchanges of the second resource for the first resource.

4. The method of claim 1, wherein maintaining the desired level of the first resource relative to the second resource is performed by at least one asset backing interface node that maintains the desired level of the first resource relative to the second resource.

5. The method of claim 4, wherein the at least one asset backing interface node provides an interface to the pool of the first resource to allow for netting out of exchanges of the first resource for the second resource against exchanges of the second resource for the first resource.

6. The method of claim 1, wherein the first threshold and the second threshold are selected so that the first resource is always exchangeable by a participant in the digital ledger for a known amount, value, or equivalent of the second resource.

7. The method of claim 1, further comprising:
maintaining a desired level of the second resource relative to the first resource by:
responsive to a determination that a pool of the second resource is below a third threshold value, obtaining additional units of the second resource; and
responsive to a determination that the pool of the second resource is above a fourth threshold value, transferring units of the second resource.

8. The method of claim 7, wherein the third threshold and the fourth threshold are selected so that the first resource is always exchangeable by a participant in the digital ledger for a known amount, value, or equivalent of the second resource.

9. The method of claim 7, wherein the step of transferring units of the second resource comprises transferring units of the second resource for an equivalent number of units of the first resource and adding the units of the first resource to the pool of the first resource.

10. The method of claim 7, further comprising:
determining the third threshold value based on a total amount of the first resource.

11. The method of claim 7, further comprising:
changing the third threshold value in response to an increase in the desired level of the first resource.

12. The method of claim 10, further comprising:
creating additional units of the first resource.

13. The method of claim 1, wherein the step of destroying or transferring units of the first resource based upon one or more rules in the digital ledger comprises transferring units of the first resource from the pool of the first resource to another owner of units of the first resource.

14. The method of claim 1, wherein the pool of the first resource and the pool of the second resource are held by the digital ledger.

15. The method of claim 1, wherein the rules in the digital ledger are enforced by one or more smart contracts within the digital ledger.

16. The method of claim 1, wherein the first resource comprises a digital token, a representation of usable computing resources, or a unit of a cryptocurrency.

17. The method of claim 1, wherein the second resource comprises a fiat currency, a tangible property, or an amount of actual used computing resources.

18. The method of claim 1, wherein the digital ledger is a distributed ledger.

19-20. (canceled)

21. A system comprising one or more computing devices configured to:
set a per-unit value of a first resource managed by a digital ledger relative to a second resource;
maintain at least two interface nodes where the first resource is exchangeable for the second resource at the set per unit value;
maintain a desired level of the first resource relative to the second resource by:
responsive to a determination that a pool of the first resource is below a first threshold value, obtaining or creating additional units of the first resource based upon one or more rules in the digital ledger; and
responsive to a determination that the pool of the first resource is above a second threshold value, destroying or transferring units of the first resource based upon one or more rules in the digital ledger.

22. A computer-readable medium storing a plurality of instructions which, when executed by a computer, cause the computer to:
set a per-unit value of a first resource managed by a digital ledger relative to a second resource;
maintain at least two interface nodes where the first resource is exchangeable for the second resource at the set per unit value;
maintain a desired level of the first resource relative to the second resource by:
responsive to a determination that a pool of the first resource is below a first threshold value, obtaining or creating additional units of the first resource based upon one or more rules in the digital ledger; and
responsive to a determination that the pool of the first resource is above a second threshold value, destroying or transferring units of the first resource based upon one or more rules in the digital ledger.
